(19) United States
(12) Patent Application Publication
(10) Pub. No.: US 2004/0039691 A1
(43) Pub. Date: Feb. 26, 2004

(54) Electronic funds transaction system

(76) Inventors: Robert E. Barratt, Boynton Beach, FL (US); Glenna S. Barratt, Boynton Beach, FL (US); John A. Burnor, Royal Palm Beach, FL (US)

Correspondence Address: MOTOROLA INC, 600 NORTH US HIGHWAY 45, LIBERTYVILLE, IL, 60048-5343, US

(21) Appl. No.: 10/219,208

(22) Filed: Aug. 15, 2002

(51) Int. Cl. G06F 17/60

(52) U.S. Cl. 705/39; 705/41

(57) ABSTRACT

An electronic funds transaction system (100, 400) provides for communication with an account holder's client device (118) in the course of processing credit or debit transactions. According to certain embodiments (200, 300, 500) an account holder is simply notified of requests for authorization of charges against their accounts. According to other embodiments (600, 700, 800) the account holder's authorization of charges is solicited and the authorizations of charges is made contingent upon receipt of such authorization.

### BACKGROUND OF THE INVENTION

1. Field of the Invention

This invention relates in general to financial transaction processing.

2. Description of Related Art

The proliferation of electronic Point-of-Sale (POS) terminals, along with the proliferation of debit cards that are tied to consumers checking accounts, and are supported by major card associations (e.g. VISA), have led to an increase in the use of credit and debit cards by consumers.

Credit and debit card fraud has been a perennial problem in the credit card industry. Recent developments in electronic commerce have brought with them new methods for perpetration of fraud. The increase in electronic commerce web sites has been accompanied by an increase in the number of server computers that contain repositories of credit and debit card data, and are vulnerable to theft. Thefts by external hackers and by insiders have occurred. The Internet has also served as a means for distributing stolen credit cards. Stolen credit card numbers have been posted in members only web sites that are hosted on servers in countries where aggressive law enforcement is problematic. The Internet also provides venues for the use of stolen credit card numbers, in the form of enumerable web based merchants.

Certain security systems and protocols have been developed. For example an Address Verification Systems (AVS) has been implemented by some credit card processors. In the AVS system, address information is submitted along with credit card data, and checked against information on file at a credit card issuing bank. Another type of security measure relies on a security code that is imprinted on the back of debit or credit cards. This number is often required to be submitted in transactions between remotely located purchasers and merchants. In such instances, signing of an authorization by the purchaser is infeasible. Fraud check systems that use heuristic rules based on patterns of use (e.g., geography, time) of a particular credit or debit card have also been tried. In spite of these security measures credit card fraud continues to occur.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram of a system for performing electronic transactions according to the preferred embodiment of the invention;

FIG. 2 is a flow chart of a process executed by an issuing bank system in the system illustrated in FIG. 1 according to the preferred embodiment of the invention;

FIG. 3 is a flow chart of a process executed by a client device in the system illustrated in FIG. 1 according to the preferred embodiment of the invention;

FIG. 4 is a block diagram of a system for performing electronic transactions according to a first alternative embodiment of the invention;

FIG. 5 is a flow chart of a process executed by a computer in the system illustrated in FIG. 4 according to the first alternative embodiment of the invention;

FIG. 6 is a flow chart of a process executed by a computer in the system shown in FIG. 4 according to a second alternative embodiment of the invention;

FIG. 7 is a flow chart of a process executed by the issuing bank computer in the system illustrated in FIG. 1 according to a third alternative embodiment of the invention; and

FIG. 8 is a flow chart of a process executed by the client device accord to the second and third alternative embodiments of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

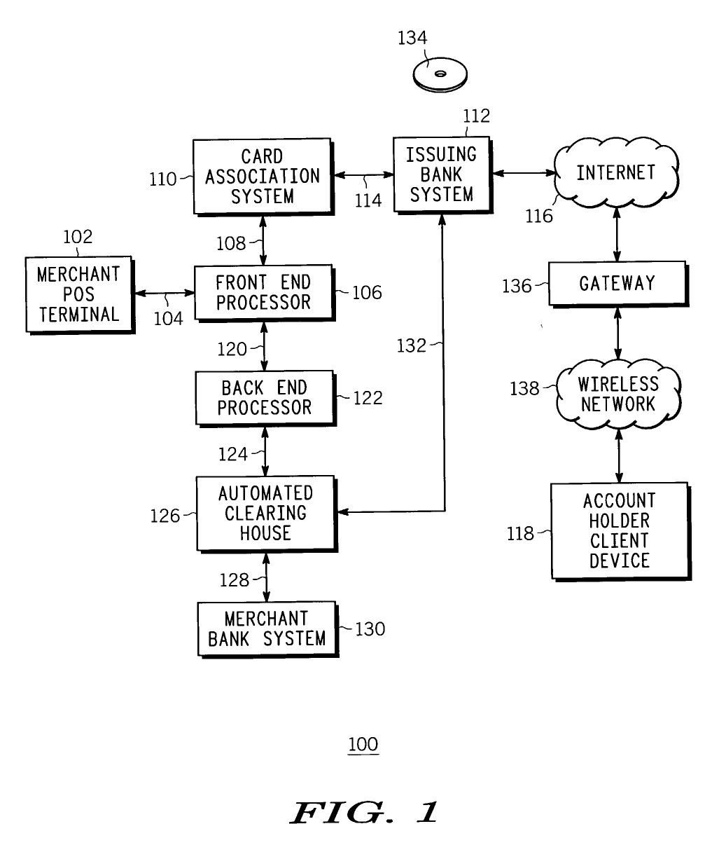

FIG. 1 is a block diagram of a system 100 for performing electronic transactions according to the preferred embodiment of the invention. Referring to FIG. 1, the system 100 will be described. A merchant POS terminal 102 is coupled through a first bi-directional data link 104 to a front end processor 106. In the case of a web based merchant, a web based software application that accepts credit card information that is entered into a web page form and transmits that information to the front end processor is used as the merchant POS terminal 102. In a brick and mortar store, the merchant POS terminal 102 is a hardware device which interoperates with, or is integrated with a cash register or a separate device. The merchant POS terminal 102 is used to enter data from a credit or debit card with which a customer intends to pay for a product or service. The merchant POS terminal 102 transmits requests for authorization to charge purchases against credit or debit accounts to the front end processor 106. Each request for authorization preferably includes information identifying a credit or debit account; an amount to be charged; a name of a merchant requesting authorization to make a charge. The information identifying the credit or debit card can be entered manually (e.g., into a numeric key pad or via a web form) or read by a card reader included in the merchant POS terminal 102. Although presently, plastic cards that include embossed and magnetically stored information are used as physical evidence of possession of deposit or credit account, and to store account information, the present invention should not be construed as limited to use of such credit or debit cards. Other types of physical tokens of deposit or credit accounts can be used in conjunction with the present invention. In practice numerous merchant POS terminals 102 are coupled to the front end processor 106.

The front end processor 106 is a computer system that is maintained by a business that is also referred to as a front end processor. The front end processor business is retained by an acquiring bank to provide credit card processing services to merchants. The acquiring bank assumes certain financial risks associated with processing credit card transactions. The acquiring bank assumes such risks based on a business relationship with a merchant bank with whom a merchant operating the merchant POS terminal 102 has an account. In some instances a merchant bank may have its own front end processor business. The front end processor business can in some instances maintain the bi-directional data link 104. The bi-directional data link 104, and other bi-directional data links described herein can for example comprise conventional telephone lines, leased lines, Digital Subscriber Lines (DSL), Wide Area Networks (WAN), the Internet, or a Virtual Private Network (VPN).

The front end processor 106 includes one or more computers. In the case of plural computers, the plural computers are coupled together through one or more communication systems. The front end processor 106 receives requests for authorization of charges against credit or a deposit accounts from the merchant POS terminal 102.

The front end processor 106 is coupled through a second bi-directional data link 108 to a card association system 110. Presently there are a few dominant card associations, among which, VISA and MasterCard are well known. The card association system 110 includes computers and communication networks interconnecting the computers. The front end processor 106 forwards each request for authorization that is received from the merchant POS terminal 102 to the card association computer system 110. The card association system 110 identifies an issuing bank, that maintains the account associated with the credit or debit card that is identified in the request for authorization. The card association computer system 110 then transmits the request for authorization to an issuing bank system 112 that is operated by the identified issuing bank. The card association computer system 110 is coupled to the issuing bank system 112 through a third bi-directional data link 114.

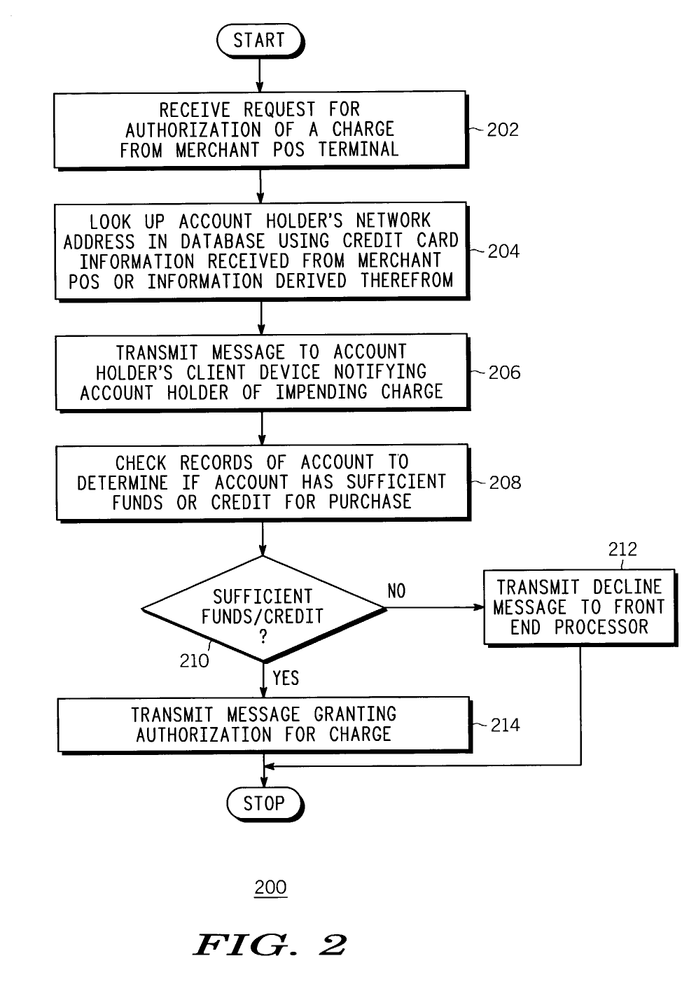

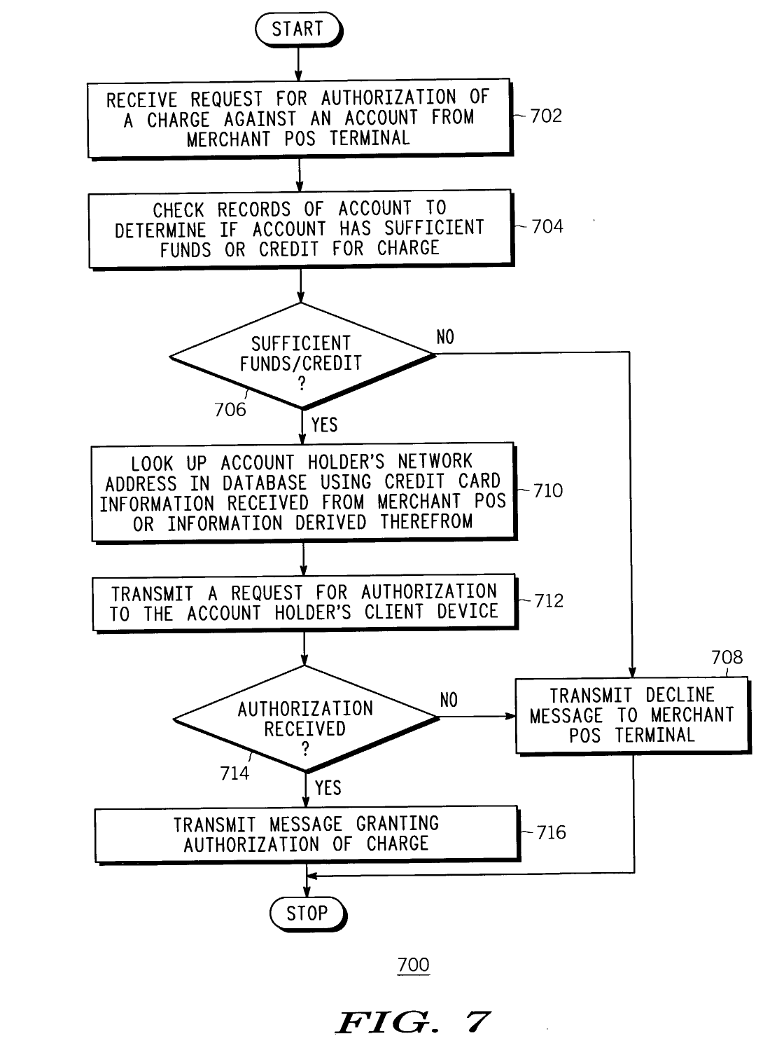

The issuing bank system 112 makes an assessment as to whether authorization is to be granted, and communicates a result of that assessment back to the card association system 112. A preferred process and an alternative process to be performed by the issuing bank system 112 in assessing whether authorization is to be granted are described below with reference to FIGS. 2 and 7 respectively. A first computer readable medium 134 is provided for loading software into the issuing bank system 112, for configuring the issuing bank system 112 to perform the processes that are described with reference to FIGS. 2 and 7.

The issuing bank system 112 is coupled through one or more networks to an account holder's client device 118. As shown in FIG. 1 according to the preferred embodiment of the invention, the issuing bank system 112 is coupled through the Internet 116, a network to network gateway 136, and a wireless network 138 to the account holder's client device 118. The account holder's client device 118 preferably comprises a portable wirelessly connected client device that is likely to be carried by the account holder. In the preferred case the portable wirelessly connected client device preferably comprises a text messaging device, a wireless telephone that includes text messaging functionality, or a wireless connected personal digital assistant (PDA). In an alternative case the account holder's client device 118 is a computer that is connected via a wired connection (e.g., MODEM or DSL) to the Internet 116. In the preferred embodiment, the gateway 136 preferably comprises a Wireless Application Protocol (WAP™) gateway that includes a WAP push gateway program. WAP is a trademark of the Wireless Application Protocol Forum. In the case that the gateway 136 runs a WAP push gateway program, the issuing bank system 112 preferably includes a WAP push initiator program. WAP push technology is a preferred way for messages to be sent at the initiation of the issuing bank system.

The account holder holds an account to which the credit or debit card that has been read at the merchant POS terminal 102 is tied. A message including information pursuant to the request for authorization is communicated by the issuing bank system 112, through the communication networks 116 138 to the account holder's client device 118. The message including information pursuant to the request for authorization preferably takes the form of a Service Indication (SI) type WAP message that is pushed to the account holder's client device 118. The account holder's client device 118 is addressed by a phone number or email address or other type of network address. Network addresses for account holder's are preferably stored in along with account information in computer readable records. The issuing bank system 112 looks up the network address using account information (e.g., credit card number) received from the card association system 110 as a record key. The type of addressing that is used depends on the configuration of the gateway 136, and or wireless network 138. The message preferably includes at least an indication of the amount of an impending charge for which authorization has been requested and the name of the merchant operating the merchant POS terminal 102. Upon receipt of the information pursuant to the request for authorization, the account holder's client device 118 preferably generates an optical, audible or tactile alert, so as to alert the account holder of the receipt of the information.

The invention provides system 100 which apprises account holder's of impending charges against their accounts. By providing notification of impending charges, the system 100 affords the account holder an opportunity to take action to stop fraudulent charges. Upon receiving notification of an impending fraudulent charge, the account holder can contact the appropriate authorities, e.g., the card issuing bank, to stop the impending charge. The message including the information pursuant to the request for authorization optionally includes a telephone number to call, if the card holder believes the impending charge to be fraudulent, or includes an email address, to which a message is to be sent if the card holder believes that the impending charge is fraudulent. One application of the system 100, is to notify primary card holder's of charges by secondary card holder's. Although in FIG. 1 a single account holder client device 118 is shown, the issuing bank system 112 is alternatively configured to transmit messages pursuant to requests for authorization of charges against a given account to more than one client device. For example, the issuing bank system 112 is alternatively configured to transmit messages pursuant to requests for authorization to an email account that is ordinarily accessed via the card holder's personal computer, and to the account holder's wireless client device. However, in some cases there may be no effective distinction between such message destinations, in as much as the same email can be forwarded from one destination to another.

Authorization or a denial of authorization, as the case may be, is communicated by the issuing bank system 112 back through the card association system 110, and front end processor 106, to the merchant POS terminal 102. On the basis of the authorization of denial of authorization the merchant determines whether or not to accept the credit or debit card proffered by the customer.

The front end processor 106 is coupled through a fourth bi-directional data link 120 to a back end processor 122. The back end processor 122 is coupled through a fifth bi-directional data link 124 to an automated clearinghouse 126. The automated clearinghouse 126 can for example be an automated clearinghouse that is maintained by the Federal Reserve Bank. The automated clearing house 126 is coupled through a sixth bi-directional data link 128 to a merchant bank system 130, and is coupled through a seventh bi-directional data link 132 to the issuing bank system 112.

In the case that authorization is granted, after receiving the authorization, the merchant POS terminal 102 retransmits transaction data including an amount of the transaction and the account information. In response to retransmitted transaction data received from the merchant POS terminal 102, the front end processor 106 communicates transaction data to the back end processor 122 which in turn transmits a request to the automated clearing house 126 for an electronic transfer of funds between issuing bank system 112 and the merchant bank system 130. Funds are transferred electronically between an account identified by the credit or debit card, and maintained by the issuing bank system, and an account maintained by the merchant bank system that belongs to the merchant operating the merchant POS terminal 102.

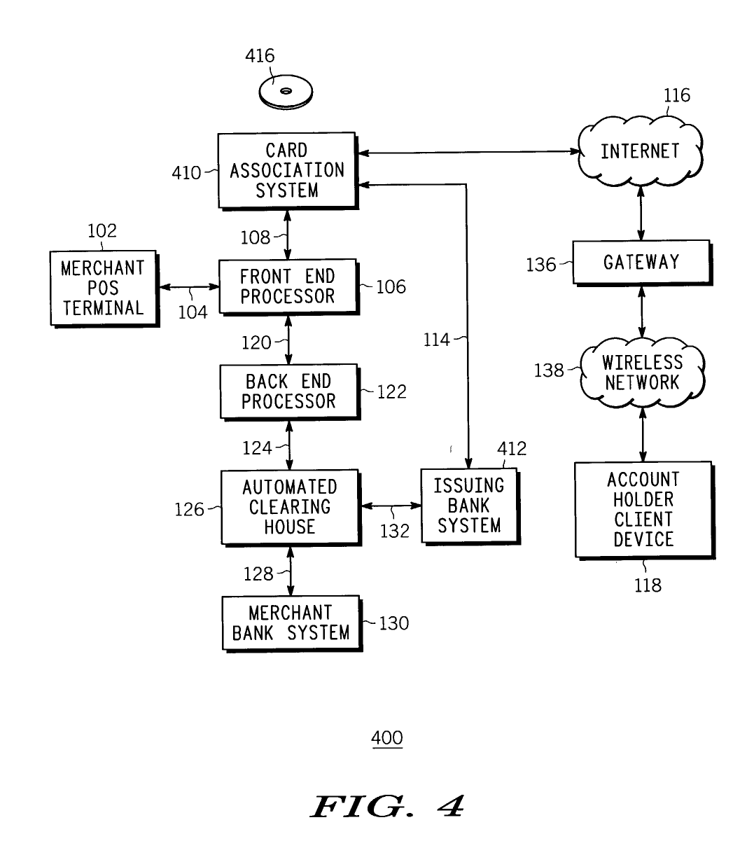

Various aspects of the infrastructure associated with certain debit or credit cards is more integrated than the system described above. For example, American Express and Discover serve as their own issuing bank and card association system 110. The invention can be adapted to system topologies other than that illustrated in FIG. 1 and that illustrated in FIG. 4 which is described below. The invention should not be construed as limited to use in connection with the particular system topologies illustrated in FIGS. 1 and 4. The system topologies illustrated in FIGS. 1 and 4 are merely exemplary and are illustrated in a broad schematic manner.

FIG. 2 is a flow chart of a process 200 executed by the issuing bank system 112 in the system 100 illustrated in FIG. 1 according to the preferred embodiment of the invention. Referring to FIG. 2, in step 202 the request for authorization of a charge against a debit or credit account is received from the merchant POS terminal 102 via the front end processor 106 and the card association system 110. In step 204 an account holder's network address is looked up in a database using credit card information received from the POS terminal 102 in step 202 as part of the request for authorization. A subset of the credit card information or information derived from the credit card information is alternatively used to locate the network address in the database. The database that correlates credit card information and associated network addresses is, according to the preferred embodiment, part of the issuing bank system 112. In step 206 the message including information pursuant to the request for authorization is sent to the account holder's client device 118, using the network address identified in step 204, thereby notifying the account holder of an impending charge. In step 208 records of the account identified in the request for authorization are checked to determine if the account has sufficient funds or available credit for the amount of the purchase that is included in the request for authorization. Block 210 is a decision block, the outcome of which depends on whether there are sufficient funds or available credit. If there are not sufficient funds or available credit then the process 200 branches to step 212 in which a message declining authorization is sent to the merchant POS terminal 102 via the card association system 110 and the front end processor 106. If there are sufficient funds or available credit, then the process 200 continues with step 214 in which a message granting authorization for the charge is sent to the merchant POS terminal 102 via the front end processor 106 and the card association system 110.

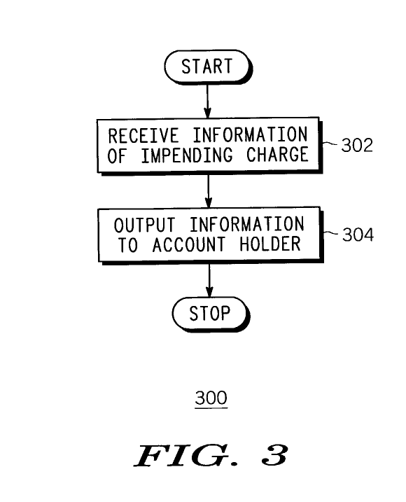

FIG. 3 is a flow chart of a process executed by the client device 118 in the system 100 illustrated in FIG. 1 according to the preferred embodiment of the invention. In step 302 information of the impending charge, i.e., the information transmitted in step 206, is received by the client device 118. In step 304 the information of the impending charge is output to the account holder. Step 304 is preferably accomplished by displaying information on a display of the client device 118. Step 304 is preferably preceded or accompanied by the activation of an alert of the client device 118.

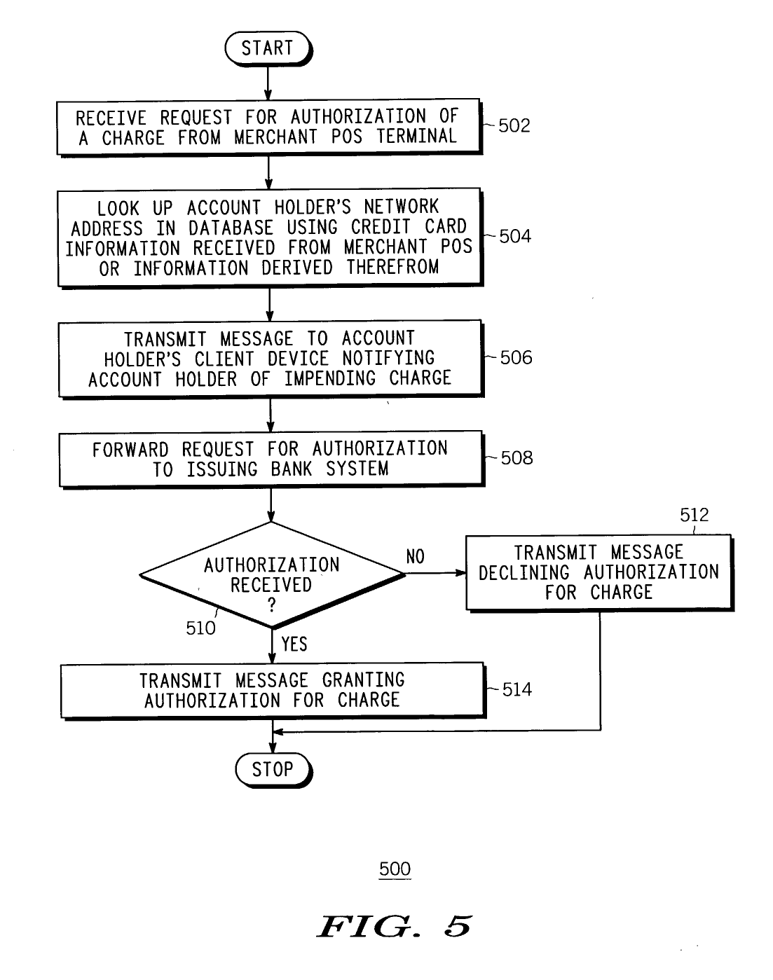

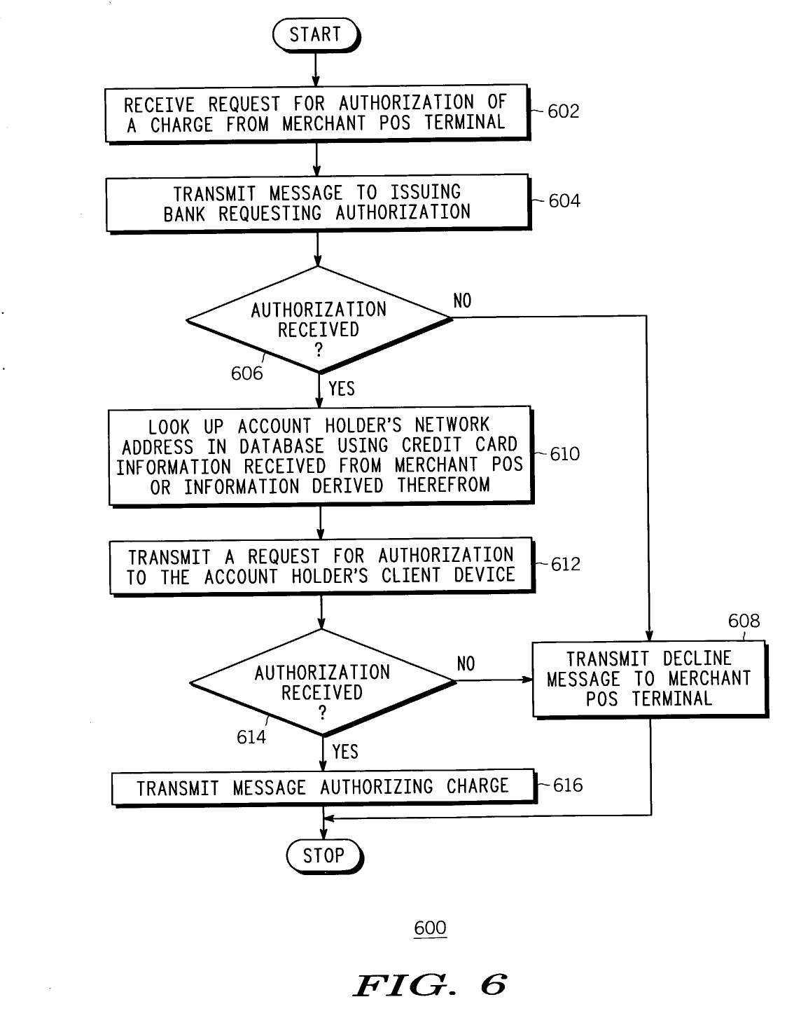

FIG. 4 is a block diagram of a system 400 for performing electronic transactions according to a first alternative embodiment of the invention. In the first alternative system 400, a card association system 410, rather than an issuing bank system 412, performs the role of communication information about impending charges to the account holder's client device 118. The card association system 410 of the first alternative system 400 is coupled to the account holder's device 118 through the Internet 116, the network to network gateway 136 and the wireless network 138. A second computer readable medium 416 is provided for loading software into the card association system 410, for configuring the card association system 410 to perform the processes that are described with reference to FIGS. 5 and 6.

FIG. 5 is a flow chart of a process 500 executed by a computer in the system illustrated in FIG. 4 according to the first alternative embodiment of the invention. The process 500 is preferably executed by a computer or computers in the card association system 410. Alternatively, the process 500 is executed by a computer or computers in the front end processor 106. In an alternative that is particularly applicable in the latter case, the front end processor 106, rather than the card association system 410 is coupled to the account holder's client device 118 through the Internet 116, the gateway 136, and the wireless network 138.

Referring to FIG. 5, in step 502 the request for authorization of a charge is received from the merchant POS terminal 102. In step 504 an account holder's network address is looked up in a database using credit card information received from the POS terminal 102 in step 502 as part of the request for authorization or information derived there from. According to the first alternative embodiment, a database that correlates credit card information and associated account holder network addresses is preferably part of the card association system 410. In step 506 a message is sent to the account holder's client device 118 notifying the account holder of the impending charge. In step 508 the request for authorization is forwarded to an issuing bank system 412. Note that the request format of the request for authorization can change and data can be added to or removed from the request for authorization as the request for authorization moves through the systems 100, 400. Block 510 is a decision block the outcome of which depends on whether authorization is received in response to the request for authorization. If authorization is not received, then the process continues with step 512 in which a message declining authorization for the impending charge is sent to the merchant POS terminal 102. On the other hand, if authorization for the impending charge is received, then the process 500 continues with step 514 in which a message granting authorization for the impending charge is sent to the merchant POS terminal 102.

In processes 200, and 500 described above messages are sent to the account holder's client device 118 pursuant to requests for authorization of charges. The processes described below with reference to FIGS. 6 and 7 go beyond what is explicitly shown in FIGS. 2 and 5, in that the account holder's authorization for impending charges is solicited.

FIG. 6 is a flow chart of a process 600 executed by a computer in the system 400 shown in FIG. 4 according to a second alternative embodiment of the invention. The second alternative process 600 is preferably executed by the card association system 410. Alternatively, the second alternative process 600 is executed by the front end processor 106. Referring to FIG. 6, in step 602 the request for authorization of the charge is received from the merchant POS terminal 102. In step 604 a message is sent to the issuing bank system 412 requesting authorization of the charge. Block 606 is a decision block the outcome of which depends on whether authorization of the charge is received from the issuing bank system 412. If authorization is not received, then the process 600 branches to step 608 in which a message declining authorization is sent to the merchant POS terminal 102. If, on the other hand, authorization is received, then the process 600 continues with step 610 in which an account holder's network address is looked up in a database using credit card information received from the POS terminal 102 in step 602 as part of the request for authorization. In step 612, a request for authorization of the charge is sent to the account holder's client device 118. The request for authorization that is sent in step 610 is preferably sent in real time through a low latency network. Real time in this instance means within less than one-minute. Block 614 is a decision block, the outcome of which depends on whether a message authorizing the charge is received in response to the message to the account holder's client device 118. If the message authorizing the charge is not received, then the process 600 branches to step 608 in which the message declining authorization is sent to the merchant POS terminal 102. If, on the other hand a message authorizing the charge is received in response to the message to the account holder's client device 118, then the process 600 continues with step 616 in which a message granting authorization of the charge is sent to the merchant POS terminal 102. Process 600 preferably allows for a certain limited time within which messages authorizing the charge are to be received before authorization is considered not to have been received. One possible variation of the second alternative process is to execute step 610 concurrently, immediately after, or before step 604. One skilled in the art will appreciate that the order of performing certain steps can be varied, and certain steps can be executed concurrently.

FIG. 7 is a flow chart of a process executed by the issuing bank system 112 in the system 100 illustrated in FIG. 1 according to a third alternative embodiment of the invention. Referring to FIG. 7, in step 702 a request for authorization of a charge against an account is received from the merchant POS terminal 102. In step 704 records of an account identified in the request for authorization are checked to determine if the account has sufficient funds or credit for the charge. Block 706 is a decision block the outcome of which depends on whether the account has sufficient funds or credit for the charge. If the account does not have sufficient funds or credit for the charge, then the process 700 branches to step 708 in which a message declining authorization of the charge is sent to merchant POS terminal 102. If, on the other hand, the account does have sufficient funds or credit for the charge, then the process 700 continues with step 710 in which an account holder's network address is looked up in a database using credit card information that was received from the POS terminal 102 in step 702 as part of the request for authorization. In step 712 a request of authorization of the charge is sent to the account holder's client device 118. Block 714 is a decision block, the outcome of which depends on whether authorization is received from card holder's client device 118. If authorization is not received in block 714 then the process 700 branches to step 708 in which the message declining authorization is sent to the merchant POS terminal 102. If on the other hand authorization is received in block 714 from the card holder's client device 118, then the process 700 continues with step 716 in which a message granting authorization of the charge is sent to merchant POS terminal 102. The messages sent in steps 708 and 716 are sent through the card association system 110, and the front end processor 106.

The messages sent in step 612 of process 600, and step 712 of process 700 are preferably SI WAP messages that include at least a hyperlink of a Uniform Resource Identifier (URI) that points to a subprogram of process 600 or process 700 for receiving authorizations from the account holder client device 118. The hyperlink is preferably an eXtensible HyperText Markup Language Mobile Profile (XHTMLMP) hyperlink or alternatively is another flavor of HTML. The subprogram pointed to by the URI is preferably a Java™ Servlet, or a Common Gateway Interface (CGI) script. Java is a trademark of Sun Microsystems. For use in connection with the process 600 and process 700, the gateway 136 preferably includes a proxy program for receiving responses (e.g., WAP responses) from the client device 118 and forwarding those responses to the system that is executing the process 600 or 700.

The messages sent in steps 612 and 712 optionally include an additional XHTMLMP hyperlink for explicitly declining to grant authorization of the impending charge. If two hyperlinks are provided, they can point two different server subprograms or point to the same server subprogram but include different appended data. The appended data can take the form of a key-value pair appended to the URI which is preferably specified in an HREF attribute of a hyperlink. For example appended data of the form Authorize=NO, and Authorize=Yes might be used in hyperlinks for declining and granting authorization. The messages sent in steps 612 and 712 are optionally encrypted.

Optionally, in response to receiving an explicit message declining authorization from the account holder's client device 118, a message is sent by the system running process 600 or 700 to the merchant pos terminal 102 instructing the merchant to seize and destroy the proffered credit or debit card.

When the messages sent in steps 612 and 712 are decoded by the card holder's client device 118, the card holder's client device 118 presents two options to the card holder. The two options presented to the card holder are to authorize the charge and to decline to authorize the charge. The card holder selects one of the options and accordingly (e.g., in accordance with the WAP) a response message is generated by the client device 118. Selection of one of the options is preferably entered by a keypad, touch screen or pointing device that is included in the card holder client device 118.

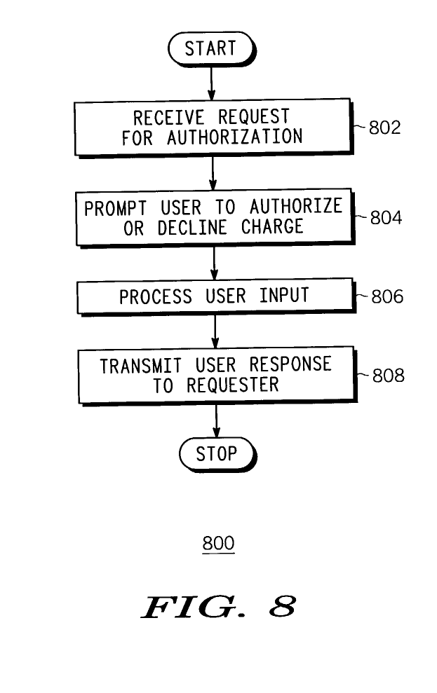

FIG. 8 is a flow chart of a process 800 executed by the client device 118 according to the second and third alternative embodiments of the invention. In step 802 a request for authorization of a charge is received. In step 804 the user is prompted to authorize or decline to authorize the charge. In step 806 the user's input is processed, and in step 808 the user's response is transmitted to requester. The requester is alternatively the card association system 110 or the front end processor 106 as mentioned above in connection with process 600, or the issuing bank system 112 as mentioned above in connection with process 700.

The processes illustrated in FIGS. 2-3, 5-8 are performed by one or more subprograms. As will be apparent to those of ordinary skill in the pertinent arts, the invention may be implemented in hardware or software or a combination thereof. Programs embodying the invention or portions thereof may be stored on a variety of types of computer readable media including optical disks, hard disk drives, tapes, programmable read only memory chips. Network circuits may also serve temporarily as computer readable media from which programs taught by the present invention are read.

The system that carries out processes 600 or 700 is alternatively programmed to selectively solicit authorization of charges from account holder's in accordance with certain specified criteria. For example, authorization can be solicited from a card holder, only in the case that a transaction exceeds a certain predetermined amount. Such an amount can be an amount specified by the account holder, issuing bank, card association, merchant or other party. Alternatively, the systems that carry out processes 600 or 700 are programmed to solicit authorization from the account holder only in the case that authorization is requested for a transaction that departs from usual patterns of usage of the account in question as determined for example based on heuristic rules regarding usual location, and time of charges. Similarly, the system that carries out processes 200, and 500 is alternatively programmed to transmit notification of charges only in accordance with certain specified criteria, such as mentioned in the preceding examples.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed:

1. A method for operating one or more computers in a system for authorizing charges against accounts comprising the steps of:
receiving a request for authorization to accept a charge against an account belonging to an account holder;
transmitting a message to the account holder's client device, informing the account holder of the request for authorization.

2. The method according to claim 1 wherein the step of transmitting the message includes the sub-step of:
transmitting an amount of the charge.

3. The method according to claim 1 wherein the step of transmitting the message includes the sub-step of:
transmitting a name of a merchant originating the request for authorization.

4. The method according to claim 1 wherein:
the message is transmitted through a wireless network.

5. The method according to claim 1 wherein:
the message is transmitted in less than one minute.

6. The method according to claim 1 further comprising the step of:
after receiving the request for authorization and prior to transmitting the message, looking up the account holder's network address using information received in the request for authorization.

7. A method for operating a system for authorizing charges against accounts, the method comprising the steps of:
receiving a first request for authorization to accept a charge against an account;
in response to receiving the first request, transmitting a second request for authorization to accept the charge against the account to an account holder's client device; and
in the case that a first authorization to accept the charge against the credit line is received in response to the second request for authorization, transmitting a second authorization to accept the charge in response to the first request for authorization.

8. The method according to claim 7 wherein:
the step of transmitting the second request comprises the sub-step of:
transmitting the second request for authorization to accept the charge through a wireless network.

9. The method according to claim 7 wherein:
the step of transmitting the second request comprises the sub-step of:
transmitting a hyperlink that includes a uniform resource identifier that points to a subprogram for processing the first authorization.

10. The method according to claim 7 wherein:
the step of transmitting the second request comprises the sub-step of:
transmitting the second request in encrypted form.

11. The method according to claim 7 wherein:
the step of transmitting the second request comprises the sub-step of:
transmitting an identification of a merchant requesting authorization to make the charge.

12. The method according to claim 11 wherein:
the step of transmitting the second request comprises the sub-step of:
transmitting an amount of the charge.

13. A method for operating a client device in a system for authorizing charges, the method comprising the steps of:
receiving information of a charge against an account;
outputting information of the charge to a user.

14. A system for authorizing charges against accounts, the system comprising:
at least one communication system;
one or more computers coupled to the at least one communications system and programmed to perform the steps of:
receiving information through the at least one communications system relative to an impending charge against an account that belongs to an account holder; and
in response thereto, transmitting through the at least one communication system to a client device of the account holder, information relative to the impending charge.

15. The system according to claim 14 wherein:
the step of transmitting comprises the sub-step of:
transmitting a request for authorization of the charge against the account.

16. A computer readable medium storing programming instructions for operating a computer in a system for authorizing charges against accounts, including programming instructions for:
receiving a request for authorization to accept a charge against an account belonging to an account holder;
transmitting a message to the account holder's client device, informing the account holder of the request for authorization.

17. The computer readable medium according to claim 16 wherein the programming instructions for transmitting the message include programming instructions for:
transmitting an amount of the charge.

18. The computer readable medium according to claim 16 wherein the programming instructions for transmitting the message include programming instructions for:
transmitting a name of a merchant originating the request for authorization.

19. A computer readable medium storing programming instructions for operating a system for authorizing charges against accounts, including programming instructions for:
receiving a first request for authorization to accept a charge against an account;
in response to receiving the first request, transmitting a second request for authorization to accept the charge against the account to an account holder's client device; and
in the case that a first authorization to accept the charge against the credit line is received in response to the second request for authorization, transmitting a second authorization to accept the charge in response to the first request for authorization.

20. The computer readable medium according to claim 19 wherein:
the programming instructions for transmitting the second request comprise programming instructions for:
transmitting a hyperlink that includes a uniform resource identifier that points to a subprogram for processing the first authorization.

21. The computer readable medium according to claim 19 wherein:
the programming instructions for transmitting the second request comprises programming instructions for:
transmitting the second request in encrypted form.

22. The computer readable medium according to claim 7 wherein:
the programming instructions for transmitting the second request comprise programming instructions for:
transmitting an identification of a merchant requesting authorization to make the charge.

23. The computer readable medium according to claim 11 wherein:
the programming instructions for transmitting the second request comprise programming instructions for:
transmitting an amount of the charge.
